(19) United States
(12) Patent Application Publication
(10) Pub. No.: US 2025/0245008 A1
(43) Pub. Date: Jul. 31, 2025

(54) Real-Time Intelligent Named Pipe Tool

(71) Applicant: Bank of America Corporation, Charlotte, NC (US)

(72) Inventor: Gaurav Srivastava, Mumbai (IN)

(73) Assignee: Bank of America Corporation, Charlotte, NC (US)

(21) Appl. No.: 18/427,316

(22) Filed: Jan. 30, 2024

(51) Int. Cl. G06F 9/38; G06F 11/30

(52) U.S. Cl. CPC G06F 9/38; G06F 11/3041

(57) ABSTRACT

Various aspects of the disclosure relate to automated management of data pipelines communicating data between applications. A real-time intelligent named pipe tool is configured to manage a data pipeline by pulling data from source applications and pushing data onto the data pipeline to be consumed by one or more recipient applications. The real-time intelligent named pipe tool monitors pipeline utilization parameters to ensure the pipeline utilization remains below a threshold level. The real-time intelligent named pipe tool intelligently manages the data throughput of the data pipelines by pushing at least a portion of messages to a database or file as the utilization threshold approaches. As the utilization falls below the threshold, the real-time intelligent named pipe tool may push data from the database or file to the pipeline. The real-time intelligent named pipe tool may maintain pipeline utilization within a range of utilization values.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to manage its computer systems efficiently, effectively, securely, and uniformly, and particularly manage how internal computer systems exchange information when providing and/or supporting different products and services offered by the organization. For example, when applications use named pipelines, a common issue with these data pipelines is that they have limited capacity to hold the data that can be transferred between processes at once. Additionally, when the data pipeline utilization reaches a certain level, one or more of the applications sharing information via the pipeline may slow down and/or even freeze completely. Currently, the only option to clear these problematic data pipelines is to purge the data manually, via a reboot, or other similar method. As such, the applications become unresponsive and useful data is lost. The applications also may experience communication errors, limited functionality and other such problems over an unknown downtime until a data pipeline can be enabled again.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes monitoring and active management of data communications between applications via one or more data pipelines.

Aspects of the disclosure relate to computer hardware and software. In particular, one or more aspects of the disclosure generally relate to computer hardware and software for deploying and implementing a real-time intelligent data pipeline tool to actively monitor and/or manage data pipelines transferring information between different applications on the enterprise network. The real-time intelligent named pipe tool is used to analyze data sent between applications and process it based upon real-time and/or pre-configured parameters. The real-time intelligent named pipe tool may incorporate self-learning based on pattern recognition that may automatically create analytical models based on the available pipeline data, such as throughput, named pipe utilization, and the like, to determine when to actively manage the pipeline operation. The real-time intelligent named pipe tool may incorporate self-detection and/or self-healing capabilities for use when managing data pipelines in real-time. Additionally, the real-time intelligent named pipe tool may perform garbage collection, data pipeline purges, automatically and selectively.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for intelligent real-time management of data pipelines on an enterprise network, in accordance with one or more aspects described herein;

FIG. 1B shows an illustrative computing platform enabled for monitoring and/or managing intelligent real-time management of data pipelines on an enterprise network, in accordance with one or more aspects described herein;

FIG. 2 shows illustrative process for monitoring and/or managing intelligent real-time management of data pipelines on an enterprise network in accordance with one or more aspects described herein; and

FIG. 3 show an illustrative system for monitoring and/or managing intelligent real-time management of data pipelines on an enterprise network, in accordance with one or more example arrangements.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

A Real-time Intelligent Named Pipe (RiNP) Tool may selectively and intelligently purge data inside the named data pipeline depending on the real-time and/or configured parameters related to the data being consumed by involved applications. This entire process is real-time and does not cause any application downtime. The RiNP tool is “Self-Aware” (e.g., performs real-time monitoring of each data pipeline on the enterprise network), “Self-Learning” (e.g., identifies patterns such as by using Manhattan distance techniques, uses asymptotic values and/or builds models), “Self-Healing” (e.g., frees up named data pipelines through use of intelligent purging), “Self-Regulating” (e.g., decides when to start purging), “Self-Managing” (e.g., decides when to start loading data back to the data pipeline), “Self-Cleaning” (e.g., moving messages to alternate storage), “Self-Creating” (i.e. automatically determines when to clean-up data in the data pipeline before problems can occur and/or when to reload data back to the data pipeline), and/or “Self-Adaptive” (e.g., utilizing data management techniques based on usage parameters crossing predetermined and/or adaptive thresholds), and the like.

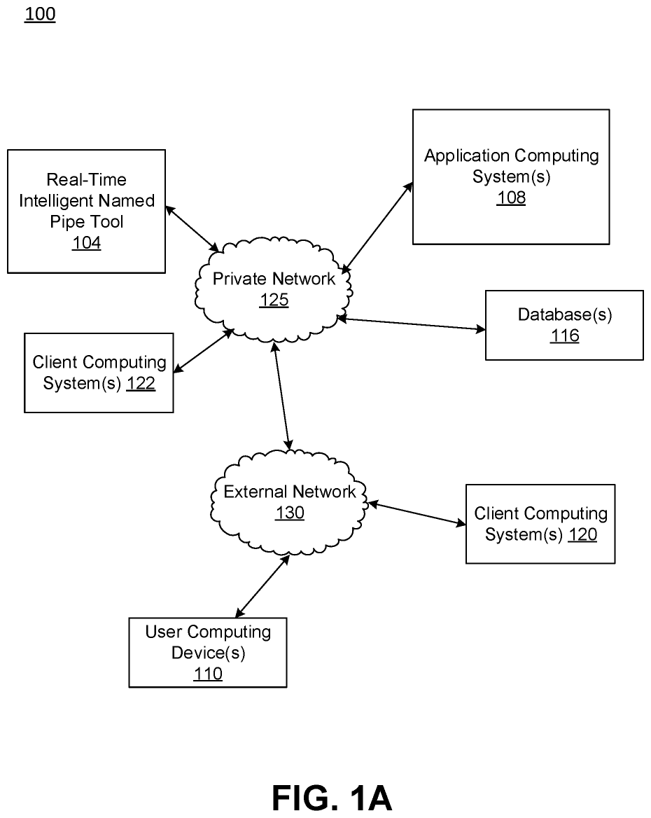

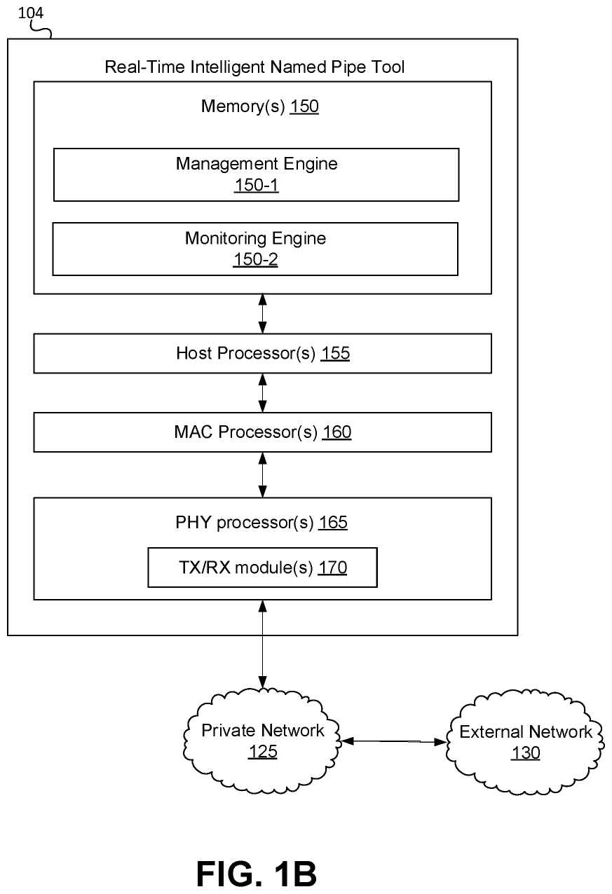

FIG. 1A shows an illustrative computing environment 100 for intelligent real-time management of data pipelines on an enterprise network, in accordance with one or more arrangements. The computing environment 100 may comprise one or more devices (e.g., computer systems, communication devices, and the like). The computing environment 100 may comprise, for example, a real-time intelligent named pipe tool 104, one or more application computing systems 108, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3rd Generation Partnership Project (3GPP) cellular protocol, a hypertext transfer protocol (HTTP), etc.). While FIG. 1A shows the real-time intelligent named pipe tool 104 as a separate device, the real-time intelligent named pipe tool 104 may be integrated within one or more separate computing systems, such as the application computing systems 108.

The real-time intelligent named pipe tool 104 may comprise one or more computing devices and/or other computer components (e.g., processors, memories, communication interfaces) configured to perform one or more functions as described herein. Further details associated with the architecture of the real-time intelligent named pipe tool 104 are described with reference to FIG. 1B.

The application computing systems 108 and/or the client computing systems 122 may comprise one or more computing devices and/or other computer components (e.g., processors, memories, communication interfaces). In addition, the application computing systems 108 and/or the client computing systems 122 may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the client computing systems 122 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The application computing systems 108 and/or the client computing systems 122 may comprise various servers and/or databases that store and/or otherwise maintain account information, such as financial account information including account balances, transaction history, account owner information, and/or other information. In addition, the application computing systems 108 and/or the client computing systems 122 may process and/or otherwise execute transactions on specific accounts based on commands and/or other information received from other computer systems comprising the computing environment 100. In some cases, one or more of the application computing systems 108 and/or the client computing systems 122 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing systems 120 may comprise one or more computing devices and/or other computer components (e.g., processors, memories, communication interfaces). The client computing systems 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing systems 120 is for processing an electronic exchange of goods and/or services. The client computing systems 120 may be associated with a specific goods purchasing activity, such as purchasing a vehicle, transferring title of real estate may perform communicate with one or more other platforms within the client computing systems 120. In some cases, the client computing systems 120 may integrate API calls to request data, initiate functionality, or otherwise communicate with the one or more application computing systems 108, such as via the services. For example, the services may be configured to facilitate data communications (e.g., data gathering functions, data writing functions, and the like) between the client computing systems 120 and the one or more application systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the real-time intelligent named pipe tool 104. For example, the database(s) 116 may store data transfer patterns, configuration files, analysis models, and/or the like. In an arrangement, the database(s) 116 may be used for other purposes as described herein. In some cases, the client computing systems 120 may write data or read data to the database(s) 116 via the services.

In one or more arrangements, the real-time intelligent named pipe tool 104, the application computing systems 108, the client computing systems 122, the client computing systems 120, the user devices 110, the databases 116 and/or the other devices/systems in the computing environment 100 may be any type of computing device capable of receiving input via a user interface, and communicating the received input to one or more other computing devices in the computing environment 100. For example, the real-time intelligent named pipe tool 104, the application computing systems 108, the client computing systems 122, the client computing systems 120, the user devices 110, the databases 116, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the real-time intelligent named pipe tool 104, the application computing systems 108, the client computing systems 122, the client computing systems 120, the user devices 110, the databases 116, and/or the other devices/systems in the computing environment 100 may, in some instances, be and/or comprise special-purpose computing devices configured to perform specific functions.

FIG. 1B shows an illustrative real-time intelligent named pipe tool 104 in accordance with one or more examples described herein. The real-time intelligent named pipe tool 104 may be a stand-alone device and/or may at least be partial integrated with the real-time intelligent named pipe tool 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The real-time intelligent named pipe tool 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the real-time intelligent named pipe tool 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the real-time intelligent named pipe tool 104 may be configured to execute machine readable instructions stored in memory 150. The memory 150 may comprise (i) one or more program modules/engines having instructions that when executed by the one or more processors cause the real-time intelligent named pipe tool 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the real-time intelligent named pipe tool 104 and/or by different computing devices that may form and/or otherwise make up the real-time intelligent named pipe tool 104. For example, the memory 150 may have, store, and/or comprise a management engine 150-1 and a monitoring engine 150-2, and/or the like. The management engine 150-1 may have instructions that direct and/or cause the real-time intelligent named pipe tool 104 to perform one or more operations associated with intelligent management of data pipeline operation via pattern recognition, buffer management techniques, purging and/or reloading data based on real-time identification and/or modification of thresholds, and the like. The monitoring engine 150-2 may have instructions that may cause the real-time intelligent named pipe tool 104 to perform real-time monitoring of one or more data pipelines transferring data between applications over an enterprise network.

While FIG. 1A illustrates the real-time intelligent named pipe tool 104 and/or the application computing systems 108, as being separate elements connected in the private network 125, in one or more other arrangements, functions of one or more of the above may be integrated in a single device/network of devices. For example, elements in the real-time intelligent named pipe tool 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application computing systems 108.

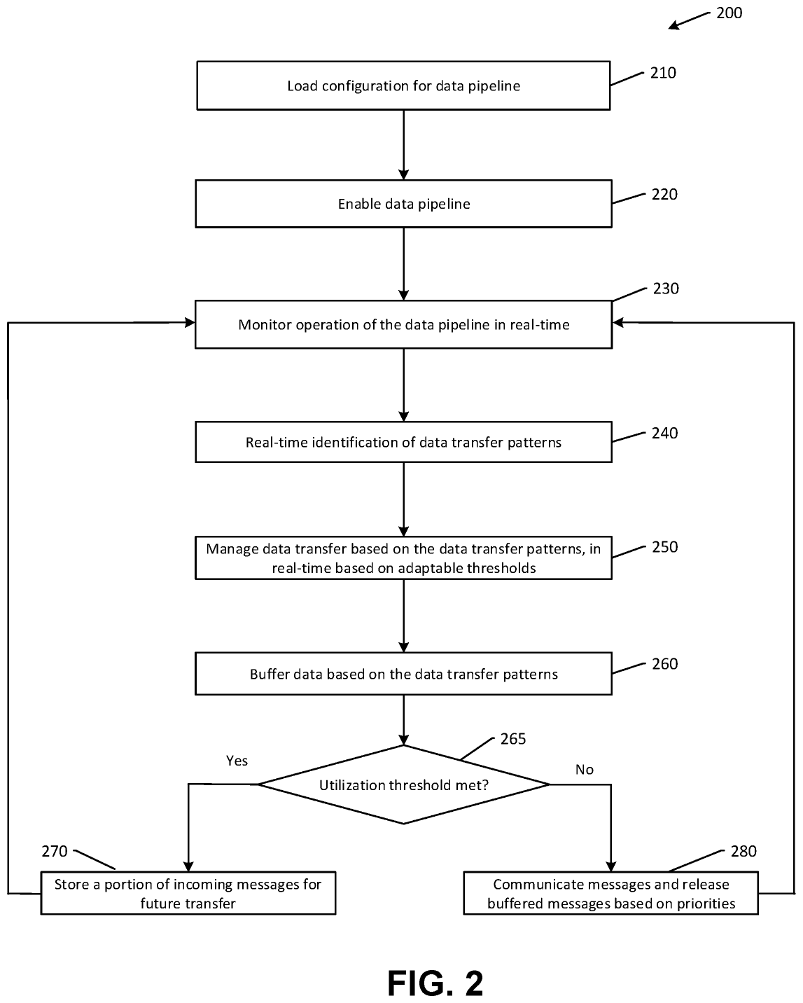

FIG. 2 shows illustrative process 200 for monitoring and/or managing intelligent real-time management of data pipelines on an enterprise network in accordance with one or more aspects described herein. At 210, the real-time intelligent named pipe tool 104 may load a configuration file for configuring a data pipeline connection between different applications (e.g., a source application and one or more recipient applications). At 220, the real-time intelligent named pipe tool 104 may enable the data pipeline and monitor operations of the data pipeline in real-time at 230. At 240, the real-time intelligent named pipe tool 104 during monitoring may identify data transfer patterns associated with the data pipeline between the applications, such as an increase and/or decrease of data messages being set at different times of the day or on different days of the week.

At 250, the real-time intelligent named pipe tool 104 may manage the data transfer over the data pipeline based on the identified data transfer patterns. For example, the real-time intelligent named pipe tool 104 may identify that messages may increase at a particular first time of day and decrease at a second time of day. Leading to those times, the real-time intelligent named pipe tool 104 may adjust a data transfer threshold (e.g., a pipeline utilization threshold) based on the identified pattern to ensure that the data pipeline does not reach a maximum data transfer threshold that may cause one or more of the applications to enter an error condition. For example, at a first time of day, the real-time intelligent named pipe tool 104 may identify that the pipeline utilization is lessened, so that a data transfer threshold may be increased (e.g. from 70% utilization to 80% utilization). Additionally, the real-time intelligent named pipe tool 104 may identify that the pipeline utilization is increased at certain times, so that a data transfer threshold may be decreased (e.g. from 80% utilization to 70% utilization) so that the increase in data messaging via a pipeline stays below the maximum allowable data transfer capacity of the pipeline.

At 260, the real-time intelligent named pipe tool 104 may cause messages to be stored in a file or database when a threshold condition is met (e.g., reaching the 70% capacity threshold). In some cases, the real-time intelligent named pipe tool 104 calculates a number of messages to be stored in the database or file based on a predicted data transfer capacity at a later time and/or based on identified data transfer patterns. If, at 265, the real-time intelligent named pipe tool 104 identifies that the pipeline utilization threshold is met (or predicted to be met within a specified timeframe (e.g., 5 minutes, 10 minutes, 30 minutes, and the like), the real-time intelligent named pipe tool 104 continues to store at least a portion of incoming messages to the file or database. If not, the real-time intelligent named pipe tool 104 may communicate incoming messages and/or release stored (e.g., buffered) messages based on a rule set and/or message priorities at 280.

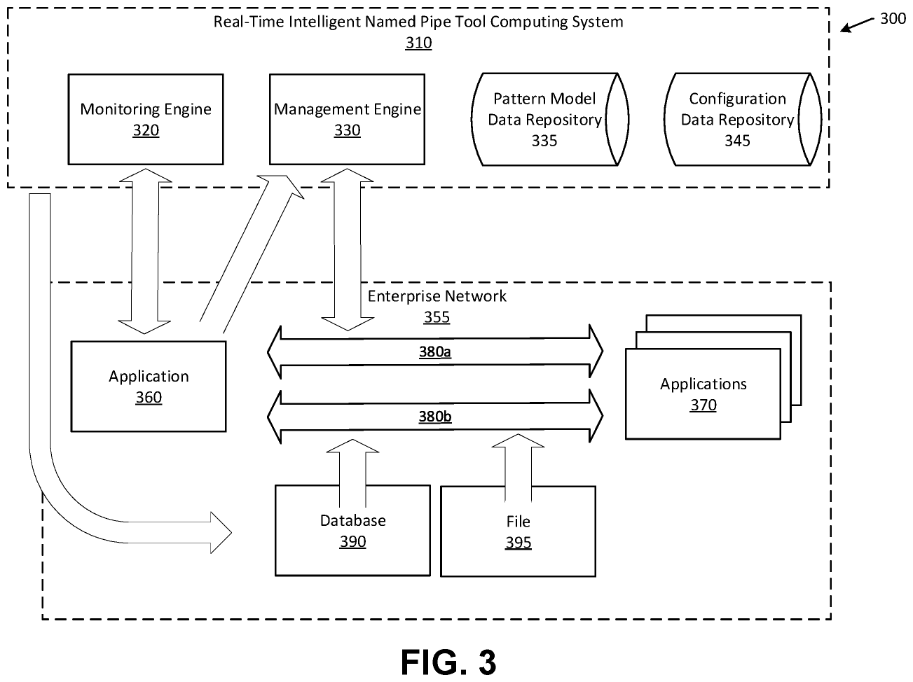

FIG. 3 show an illustrative system 300 for monitoring and/or managing intelligent real-time management of data pipelines on an enterprise network, in accordance with one or more example arrangements. The system 300 may include real-time intelligent named pipe tool computing system 310 (e.g., a real-time intelligent named pipe tool 104) that may include a monitoring engine 320, a management engine 330, a pattern model data repository 335, a configuration data repository 345, and the like. The real-time intelligent named pipe tool computing system 310 may be communicatively coupled to the enterprise network 355 that may include a plurality of application computing systems 108 running a plurality of applications such as the application 360 and the one or more applications 370. The applications may share or otherwise communicate data, such as via one or more data pipelines 380a and 380b. In some cases, based on a configuration and a communication rate meeting a configurable threshold, the real-time intelligent named pipe tool computing system 310 may facilitate data transfer between the application 360 (e.g., a source application) to one or more applications 370 (e.g., recipient applications) via one or more data pipelines 380a, 380b. Additionally, the real-time intelligent named pipe tool computing system 310 may utilize one or more databases (e.g., database 390) and/or files (e.g., file 395) to temporarily store messages in real-time to ensure the data pipelines 380a and/or 380b remain active and under their maximum data transfer capacity.

The data pipeline is a communication channel between two application used for transferring data, where data sent by a sending application 360 is consumed by the receiving application 370. Often, the data pipeline may be subject to communication error-related issues that may cause the data pipeline to timeout, which in turn causes one or more of the applications 360 and 370 to issue errors and/or crash. As long as the data pipeline can facilitate data creation from the source application and data consumption needs of the one or more applications 370. Data pipeline issues may include pipeline timeouts, communication delays, system-wide failures, and the like. In some cases, application runtimes and/or network conditions may cause the source application 360 and the one or more recipient applications to operate at different timings. For example, a producer may source data at a first rate and a consumer application may consume data at a second rate different than the first rate. Often, data pipeline problems occur when data communication rates (e.g., more intensive communication requests and/or responses) cause the data volume to increase, where a message volume within the data pipeline may increase (e.g., exponentially) at a rate where the pipeline capacity is exceeded. The applications are running on hardware within the enterprise network 350 where network communication characteristics (e.g., jitter, delays, data collisions, interrupt conflicts, and the like) may cause issues with communications via the pipeline. Also, the data pipeline may be parameterized with a defined memory to handle an expected data communication rate (e.g., 100,000 messages per second, but this may increase (or decrease) unexpectedly where communication rates may increase quickly (e.g., to 200,000-300,000 messages per second), where the data pipeline cannot transfer the increased traffic and the pipeline may run out of memory.

The real-time intelligent named pipe tool computing system 310 may operate as an interface to a data pipeline. The source application may push data to the real-time intelligent named pipe tool computing system 310 and the real-time intelligent named pipe tool computing system 310 may then provide the messages to the pipeline. The real-time intelligent named pipe tool computing system 310 monitors usage of the data pipeline, such as to identify a utilization rate, in real-time. For example, the real-time intelligent named pipe tool computing system 310 may identify that the data pipeline is operating at 80% utilization of memory allocated for the pipeline (e.g., 1 TB memory). The real-time intelligent named pipe tool computing system 310 may be configured to predict when communications may reach the utilization threshold (e.g. 80% of allotted memory) and/or may monitor data communication rates to predict whether a number of messages is increasing at a rate likely cause a failure. The real-time intelligent named pipe tool computing system 310 may continuously monitoring message throughput through the real-time intelligent named pipe tool computing system 310 and monitors utilization of the data pipeline such as to identify different communication related parameters, such as a communication rate, memory utilization percentages, and the like.

The real-time intelligent named pipe tool computing system 310 may operate to prevent data pipeline failures, such as by identifying and/or predicting when a data pipeline may reach a threshold utilization, and to avoid a pipeline failure condition, the real-time intelligent named pipe tool computing system 310 may push messages into one or more files 395 and/or databases 395 that may operate as a message buffer. The real-time intelligent named pipe tool computing system 310 may operate such that the data pipeline utilization may never cross (or reach) a 100% utilization threshold and, as such, may prevent data pipeline failures. During this process, the data pipeline operates in a normal manner, while the real-time intelligent named pipe tool computing system 310 moves, in real-time, messages into buffering files and/or databases. Once utilization is reduced beneath the threshold, the real-time intelligent named pipe tool computing system 310 may begin (or continue) to push messages stored in the files and/or databases into the data pipeline. In an illustrative example, the real-time intelligent named pipe tool computing system 310 may enable the data pipeline 380a, 380b to operate with a consistent, or otherwise stable message volume, where the source application and the one or more destination applications will remain operational and the data pipeline maintains a stable memory usage.

In some cases, the real-time intelligent named pipe tool computing system 310 may utilize unique aspects of data pipeline management, where the real-time intelligent named pipe tool computing system 310 pulls messages from the data source applications 360 and pushes the messages onto the data pipeline when the pipeline utilization is beneath a threshold. As the utilization nears the threshold, the real-time intelligent named pipe tool computing system 310 may begin to push a portion of messages to the database, while continuing to communicate other messages via the data pipeline. In some cases, the real-time intelligent named pipe tool computing system 310 may monitor messages and identify different message characteristics, such as data types, source applications, destination applications, data communicated, and may utilize this information using a rule set to determine a message priority associated with each message. The real-time intelligent named pipe tool computing system 310 may then communicate messages via the pipeline(s) 380a and/or 380b based on the priorities and/or predicted pipeline utilization rates. Once a pipeline utilization is reduced below the threshold, the real-time intelligent named pipe tool computing system 310 may pull messages out of the database 390 and/or file 395.

The real-time intelligent named pipe tool computing system 310 monitors pipeline utilization, such as by monitoring pipeline memory capacity, where the utilization threshold may be defined as a memory amount and/or a utilization percentage of a total memory available. The utilization threshold may be configurable (e.g., 60%, 70%, 80%, and the like), where a user device 110 may be used to set the threshold value. The real-time intelligent named pipe tool computing system 310 controls the flow rate of messages through the data pipeline and maintains the pipeline utilization below a threshold value and/or within a particular utilization range (e.g., between 50% and 60% utilization). In some cases, the real-time intelligent named pipe tool computing system 310 may identify when the pipeline utilization rate is approaching a threshold and may then limit communications to slow an approach towards the utilization limit, so that the threshold utilization is not, or minimally met. For example, the real-time intelligent named pipe tool computing system 310 may identify when the utilization is nearing (e.g., at 50% or 60% of utilization) may start throttling back message communication to the data pipeline to slow an approach to the parameterized utilization threshold. Additionally, the real-time intelligent named pipe tool computing system 310 may ensure the number of messages per unit of time will not lead to crossing that utilization threshold. The threshold may be set automatically by the real-time intelligent named pipe tool computing system 310, such as by identifying data communication patterns through the data pipelines to and from certain applications. Based on the patterns, the real-time intelligent named pipe tool computing system 310 may automatically control the threshold and/or communication rates to ensure that maximum and/or minimum communication rates are set to ensure overall communication via the data pipeline is maintained without approaching a utilization limit.

In some cases, the real-time intelligent named pipe tool computing system 310, when throttling messages to or from the database 390 and/or the file 395, may apply smart logic based on communication patterns, rule sets, and the like. For example, the real-time intelligent named pipe tool computing system 310 may identify client applications and/or data sources that have a higher priority. The real-time intelligent named pipe tool computing system 310 may operate under a rule set to push high priority messages onto the data pipeline over lower priority messages. In some cases, the real-time intelligent named pipe tool computing system 310 may buffer low priority messages and may allow a subset of higher priority messages into the pipeline. In some cases, the real-time intelligent named pipe tool computing system 310 may allow older messages to be bumped in priority to ensure data does not stagnate within the database 390 and/or file 395 and is communicated via the pipeline 380a, 380b in a timely manner. In some cases, the real-time intelligent named pipe tool computing system 310 may be self-learning and may identify communication patterns over time (e.g., differing message volumes over time over a day or multiple days). The real-time intelligent named pipe tool computing system 310 may monitor data sent through the pipeline, such as at an expected throughput (e.g., 100,000 messages per second and may identify anomalies and/or times of higher utilization (e.g., increases to 110,000, 150,000, 200,000 messages). While this increase of pipeline utilization may be within the pre-define limits, the real-time intelligent named pipe tool computing system 310 may predict when the threshold may be met and may identify a direction that the communication rate is heading (rising, falling, stable, and the like), where the real-time intelligent named pipe tool computing system 310 may continuously monitor communications and may control pushing and/or pulling of data accordingly.

The real-time intelligent named pipe tool computing system 310 may be self-cleaning, where the real-time intelligent named pipe tool computing system 310 may continuously monitor the memory usage of the database 390 and/or the file 395, and may create a new file or allocate more memory to the database 390 as needed. The real-time intelligent named pipe tool computing system 310 may also manage file and/or database cleanup and/or may perform other garbage collection activities to ensure messages that are “buffered” can be timely sent via the data pipeline even if the priority of the messages is less than the higher priority messages being sent.

The real-time intelligent named pipe tool computing system 310 may be parameterized to customize operation to applications and/or network requirements. A user device 110 may be used to customize operation to prevent application failures. Currently, clients facing issues with data pipelines that crash or otherwise have stopped communicating, the applications (source and/or destination) may freeze. At this point, resetting the applications may be the only option, which often is a manual task. To avoid this, the real-time intelligent named pipe tool computing system 310 monitors threshold utilization automatically and controls and/or manages data throughput through the data pipeline by receiving messages from the source applications, and automatically pushing the messages to a buffer file and/or to the pipeline and pulling messages, according to a rule set and/or priorities, from the buffer file to the pipeline. A rule set may identify a source, a client application, and/or set priorities to ensure the real-time intelligent named pipe tool computing system 310 operates to ensure high priority messages are sent before lower priority messages. The rules may be customized and/or the rules may be manually overridden. For example, a manual override may be used to override the automatic operation of the real-time intelligent named pipe tool computing system 310. In some cases, parameterization may be used to set thresholds and/or priorities for users, sources, and destinations, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a plurality of application computing systems comprising a first application computing system providing a first application and a second application computing system comprising a second application;
a pipeline management tool platform, comprising:
a processor; and
memory storing computer-readable instructions that, when executed by the processor, cause the pipeline management tool platform to:
receive, from the first application, a plurality of data messages;
route the plurality of data messages to the second application via a data pipeline;
monitor, in real-time, operation of the data pipeline;
route, based on a data pipeline utilization rate meeting a threshold, at least a portion of the plurality of data messages to a data repository; and
push, to the data pipeline and from the data repository, messages to the data pipeline when the data pipeline utilization rate falls below the threshold.

2. The system of claim 1, wherein the instructions further cause the pipeline management tool platform to:
identify a communication pattern of data received from the first application; and
adjust, the threshold based on the communication pattern.

3. The system of claim 1, wherein the data repository comprises a database.

4. The system of claim 1, wherein the data repository comprises a file.

5. The system of claim 1, wherein the instructions further cause the pipeline management tool platform to:
cause presentation of a user interface screen at a user device, wherein the user interface screen presents a representation of data pipeline utilization information; and
receive, based on the data pipeline utilization information, rules corresponding to message priorities assigned based on message owner information.

6. The system of claim 5, wherein the instructions cause the pipeline management tool platform to:
assign, based on message owner information, a priority to each message received from the first application; and
order, based on the priority, each message sent via the data pipeline.

7. The system of claim 6, wherein the instructions cause the pipeline management tool platform to push, based on the priority, high priority messages from the data repository before low priority messages.

8. A method comprising:
receiving, from a first application, a plurality of data messages;
routing the plurality of data messages to a second application via a data pipeline;
monitoring, in real-time, operation of the data pipeline;
routing, based on a data pipeline utilization rate meeting a threshold, at least a portion of the plurality of data messages to a data repository; and
pushing, to the data pipeline and from the data repository, messages to the data pipeline when the data pipeline utilization rate falls below the threshold.

9. The method of claim 8, further comprising:
identifying a communication pattern of data received from the first application; and
adjusting, the threshold based on the communication pattern.

10. The method of claim 8, wherein the data repository comprises a database.

11. The method of claim 8, wherein the data repository comprises a file.

12. The method of claim 8, further comprising:
causing presentation of a user interface screen at a user device, wherein the user interface screen presents a representation of data pipeline utilization information; and
receiving, based on the data pipeline utilization information, rules corresponding to message priorities assigned based on message owner information.

13. The method of claim 12, further comprising:
assigning, based on message owner information, a priority to each message received from the first application; and
ordering, based on the priority, each message sent via the data pipeline.

14. The method of claim 13, further comprising pushing, based on the priority, high priority messages from the data repository before low priority messages.

15. Non-transitory computer readable media storing instructions that, when executed by a processor, cause a computing platform to:
receive, from a first application, a plurality of data messages;
route the plurality of data messages to a second application via a data pipeline;
monitor, in real-time, operation of the data pipeline;
route, based on a data pipeline utilization rate meeting a threshold, at least a portion of the plurality of data messages to a data repository; and
push, to the data pipeline and from the data repository, messages to the data pipeline when the data pipeline utilization rate falls below the threshold.

16. The non-transitory computer readable media of claim 15, wherein the instructions cause the computing platform to:
identify a communication pattern of data received from the first application; and
adjust, the threshold based on the communication pattern.

17. The non-transitory computer readable media of claim 15, wherein the data repository comprises a database.

18. The non-transitory computer readable media of claim 15, wherein the data repository comprises one or both of a file and a database.

19. The non-transitory computer readable media of claim 15, wherein the instructions cause the computing platform to:
cause presentation of a user interface screen at a user device, wherein the user interface screen presents a representation of data pipeline utilization information; and
receive, based on the data pipeline utilization information, rules corresponding to message priorities assigned based on message owner information.

20. The non-transitory computer readable media of claim 15, wherein the instructions cause the computing platform to:
assign, based on message owner information, a priority to each message received from the first application;
order, based on the priority, each message sent via the data pipeline; and
push, based on the priority, high priority messages from the data repository before low priority messages.
